(19) United States
(12) Patent Application Publication
(10) Pub. No.: US 2009/0260661 A1
(43) Pub. Date: Oct. 22, 2009

(54) Cleaning Assembly

(75) Inventor: Aleksander Lindros, Copenhagen (DK)

Correspondence Address: WILLIAM J. SAPONE;COLEMAN SUDOL SAPONE P.C., 714 COLORADO AVENUE, BRIDGE PORT, CT, 06605, US

(73) Assignee: ALFA LAVAL TANK EQUIPMENT A/S, Ishoj (DK)

(21) Appl. No.: 12/097,005

(22) PCT Filed: Jan. 30, 2007
(86) PCT No.: PCT/DK2007/000043

§ 371 Date: Oct. 20, 2008

(30) Foreign Application Priority Data
Feb. 8, 2006 (DK) PA2006 00176

(51) Int. Cl. B08B 9/093; B08B 9/08; B05B 3/04; B05B 15/02

(52) U.S. Cl. 134/167 R

(57) ABSTRACT

To achieve complete cleaning of a tank (11) by means of a cleaning head (4, 5) having nozzles (6) mounted on a liquid supply pipe (3), the cleaning head (4) according to the invention is provided with one or more nozzle openings, nozzles (7), which eject a jet/jets (8, 9) against the supply pipe/suspension (3). This ensures that the stationary parts of the cleaning equipment (3, 10) are cleaned effectively during the turning (4a) of the cleaning head (4) and thereby of the nozzle/nozzles (7).

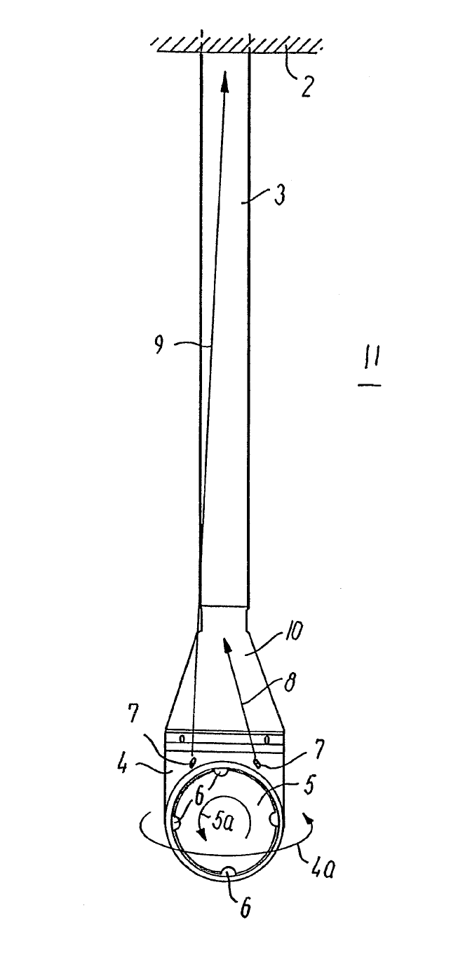

### THE PRIOR ART

The invention relates to a cleaning assembly, in particular to be mounted internally in a tank, said assembly comprising a cleaning housing mounted on a liquid supply pipe and having means for turning the housing at the same time as a hub having nozzles is rotated, and wherein one or more nozzle openings are provided on the turnable part of the housing, said nozzles ejecting a liquid jet against the supply pipe for the cleaning of it during the turning movement.

Assemblies of this type are widely used for the cleaning of tanks of any type in that nozzles eject cleaning liquid in a so-called cleaning pattern during the combined turning and rotation, such that the tank is cleaned effectively.

However, there is a need for also ensuring that the combined suspension and liquid supply system, too, is cleaned effectively.

Increasing hygiene requirements, particularly in the food processing and medicinal industries, make it necessary to ensure that everything in the tank, including the assembly, etc., is cleaned completely during the actual cleaning process.

The Patent Application US 2003/0145880 A1 discloses a solution, where the outer surfaces of the cleaning assembly itself are flushed by cleaning liquid in order to satisfy the hygiene requirements in the food processing and medicinal industries.

Some narrow openings are provided where the liquid supply pipe is introduced through the top of the tank, allowing cleaning liquid to seep down over the liquid supply pipe. Further, a nozzle is arranged in the introduction area at the top of the tank for the supply of cleaning liquid under pressure to the outer side of the liquid supply pipe. The nozzle is directed inwards toward the pipe close to the top of the tank, so that the cleaning liquid can dissolve any impurities and flow down the pipe.

However, it has been found that the cleaning effect of this solution is not as complete as is required, because the liquid jet from the nozzle or from the mentioned narrow openings for cleaning liquid cannot get into the corners in the area of the top of the tank where the liquid supply pipe is introduced.

In addition, the proposal provides no solution as to how to ensure that the cleaning head is cleaned sufficiently.

Another patent DK 171410 B1 discloses a proposal as to how the cleaning head itself may be cleaned by flushing it with cleaning liquid. Here, the gaps occurring between the fixed part and the turnable part of the cleaning head and between the hub and the turnable part of the housing, are used for ejecting cleaning liquid over the outer surface of the cleaning head. Moreover, the hub is provided with a baffle which is capable of directing the rotating cleaning jet from the gaps of the hub against the surfaces of the cleaning head. As the cleaning jets are ejected at the same time as the housing turns and the hub rotates, the entire surface of the housing is thus reached.

However, the patent provides no solution as to how the supply pipe and its introduction area through the top of the tank is cleaned.

In the patent EP0247532 by Becker a cleaning assembly is described, where an extra nozzle is placed on the housing. This should aid in the cleaning of the cleaning assembly. However, the placement of the extra nozzle is not very optimal.

### THE OBJECT OF THE INVENTION

The object of the invention is to provide an assembly to satisfy these requirements of total cleaning, and this is achieved according to the invention in that the nozzle or nozzles are provided on the side of the housing which faces toward the rotating hub.

It is ensured in this surprisingly simple manner that the parts of the assembly which are disposed above the turnable and rotating parts of the cleaning head are cleaned effectively at the same time as the other parts, i.e. tank and cleaning head, are cleaned in one and the same operation.

A liquid film is hereby produced on the surface, which cleans the external surface of the equipment.

When the nozzle or the nozzles are provided on the part of the turnable head which points toward the rotating hub having the nozzles, these additional nozzles may be configured as channels between the inner liquid space and the surface of the housing.

It is expedient, as stated in claim 2, that the jets may be adjusted so as to allow flushing, as needed, of the pipe member and the stationary part of the housing.

### The Drawing

An example of an embodiment of the assembly according to the invention will be described more fully below with reference to the drawing, which shows an assembly mounted in a tank.

### DESCRIPTION OF AN EXEMPLARY EMBODIMENT

The drawing shows a cleaning assembly mounted on a stay or a pipe 3, which extends from the tank wall 2 and a suitable distance into the tank 11.

The cleaning head itself is mounted at the end of the pipe 3 in the form of a stationary hub cone 10, in which the drive motor is present.

This motor is constructed as a liquid-driven rotor which, via a gear, partly turns the housing 4 as indicated by an arrow 4a, partly the hub 5 which is caused to rotate as indicated by an arrow 5a.

In the example shown, the rotary hub 5 has mounted thereon four nozzles 6 through which the flushing water is ejected during the combined turning 4a and rotation 5a.

According to the invention, one or more additional nozzles 7 are provided in the turnable housing 4 in the form of either bores to create nozzle openings or by means of nozzles screwed into it. These nozzles are oriented such that during the turning 4a of the housing 4 they eject one or more liquid jets upwards for the cleaning of the stationary parts, such as the hub cone 10 and the pipe 3.

As indicated by arrows 8 and 9, the jet/jets is/are adapted to sweep the parts in such a manner that all areas are cleaned thoroughly during the turning 4a, and a liquid film is produced on the surface.

The nozzle or nozzles 7 receive pressure liquid from the interior of the housing 4, and this liquid also drives the motor and is conveyed to the cleaning nozzles 6.

Hereby, both the tank 11 and the cleaning equipment 3, 10 as well as the cleaning head 4 and 5 itself are cleaned effectively upon supply of pressure liquid to the equipment.

The used cleaning liquid is sucked out from the tank in a generally known manner by means of a discharge device (not shown).

Instead of the cleaning head shown and described, the invention may also be performed on a cleaning head which is driven by a motor and a gear spaced from the cleaning head itself, e.g. in that the driving equipment is mounted externally on the tank.

1. A cleaning assembly comprising:
a cleaning housing (4) mounted on a liquid supply pipe (3) and having means for turning the housing (4) at the same time as a hub (5) having nozzles (6) is rotated
wherein one or more nozzle or nozzle openings (7) are provided on the tunable part of the housing (4),
and wherein the nozzle or nozzle openings (7) provided on the turnable part of the housing (4) comprise means suitable for ejecting a liquid jet against the supply pipe for the cleaning of the supply pipe during the turning movement of the housing (4), the nozzle or nozzle openings (7) provided on a side of the housing (4) which faces toward the rotating hub (5).

2. A cleaning assembly according to claim 1, characterized in that the nozzle or nozzle openings (7) are configured such that the jets (8, 9) are directed toward various points on a hub cone (10) or the supply pipe (3), or toward various points on both the hub cone (10) and the supply pipe (3).
